(19) United States
(12) Patent Application Publication
(10) Pub. No.: US 2014/0181650 A1
(43) Pub. Date: Jun. 26, 2014

(54) Self-configuring user interface

(71) Applicant: Michal Polubinski, Mississauga (CA)

(72) Inventor: Michal Polubinski, Mississauga (CA)

(73) Assignee: Victoria Isabella Polubinska, Mississauga (CA)

(21) Appl. No.: 14/052,630

(22) Filed: Oct. 11, 2013

Related U.S. Application Data
(60) Provisional application No. 61/712,588, filed on Oct. 11, 2012.

(51) Int. Cl. G06F 3/0484; G06F 3/0482

(52) U.S. Cl. CPC G06F 3/04842; G06F 3/0482
USPC 715/702

(57) ABSTRACT

The purpose of this invention is to provide computer or smartphone users with a self-adapting user interface and shortcuts to most frequently used actions (visual or audio).

The invention may be applied to menus and to search queries. User has a choice of recent, most frequently used, group, regional or global configuration for either menu or search query defaults. These configurations can be accessed either locally on a disconnected device, synchronized between devices directly or indirectly through a third device such as a local or remote server.

The search query can be visually configured to interact with any search engine. The uniqueness of this invention is in access to the last or most frequent uses. The resulting queries can extend from single-term to complex multi-term, multi-range combinations of inclusions and exclusions. The balancing of included search terms with excluded ones helps to eliminate unwanted finds in any database.

### CROSS-REFERENCE TO RELATED APPLICATIONS

This application claims the benefit of the provisional patent application No. 61/712,588 under 35 USC §119(e) filed on Oct. 11, 2012

### STATEMENT REGARDING FEDERALLY SPONSORED RESEARCH OR DEVELOPMENT

Not applicable

### PREAMBLE

Unless specified otherwise, in this document all examples are for explanation only. Singular cases are equivalent to plural. Single component of a set is equivalent to any combination of any elements of the set.

### BACKGROUND OF THE INVENTION

This invention is applicable to the operation of a computing device such as a server, a workstation, a desktop computer, a control system interface, a portable computer, a smartphone or a Bluetooth headset.

Prior art user interfaces such as start screens or menus require manual modification by a user to customize an interface or to assembly a search query. This task usually has to be repeated on each access point, such as a different device (a workstation, a virtual machine, a portable computing device, a smartphone, etc.), unless it is a cloud service, or synchronization of favorites or bookmarks of a browser.

Frequently repeated sequences of actions, such as selecting specific menu items have to be repeated again and again unless software developers discover the annoyance and provide a shortcut in the next version of the operating system or of software application.

In some office suite applications such as spreadsheet, changing the decimal point settings may involve up to seven steps: File>scroll down>Options>Advanced>Automatically insert a decimal point>Places>select. Moreover, the resulting selection is stored in the application settings database, instead of being specific to a workbook or a worksheet.

Many of software development business models are not sufficiently agile to capture that type of deficiency.

Most of search queries produce an overwhelming number of results. The choice of filtering and sorting options is limited. These shortcomings make specific searches tedious and very often—not leading to the desired outcome.

U.S. Pat. No. 8,239,381(¹) disclosures “A system and related techniques accept user-inputted search terms, for example to perform a search for files or other data or objects. According to embodiments, an extension of a search to different levels or points in the file system hierarchy may be automatically generated and presented to the user as a selectable search box. That box may be highlighted to the user for easy selection. When the user selects the selectable search box, the user's search for files of type or extension “.doc ” or “.memo”, may be seamlessly extended to other files, folders, trees or other points or levels in the file system hierarchy.” That patent enables the generation of an interactive search query.

U.S. Pat. No. 8,352,485(²) deals with servers providing relevant chunks of information in response to user's query containing keywords. This patent application is related to the user-side methods.

US application 20120089616 A1 (¹), refers to internet posts, i.e. it is focused on analyzing active content contribution by users and generating reports for the benefit of third parties. This invention is based on menu or query selections, which might be recorded locally or globally for the benefit of a user.

US application US2012084147 A1 (²) deals with server-side processing of search queries.

In “Self-Configuring User Interface Design”(¹), the author proposes “to develop a tool that integrates diverse subsystems and automatically configures and composes well-designed, unified, and consistent user interfaces. The purpose of such a tool would be to reduce “the time to develop user interfaces and as a powerful mechanism to provide cross-system consistency”. In other words, it is not related to self-configurable user-interface as it is disclosed in this application.

Similarly, in “Self-configuring user interface components”(²), the author describes user interface components related to software development. He asserts that “In development phases of a software, its user interface is crucial to acceptance. In early phases, rapid prototyping helps in gaining sponsors for the development project. During development, the user interface is updated to meet changing requirements and, finally, maintenance-related tasks consume a major portion of effort.”

### BRIEF SUMMARY OF THE INVENTION

The features of this invention can be divided into four different groups, as follows:
Self-adapting menu or action selection interface;
Self-generated action shortcuts;
Intuitive method of assembly of search queries, enabling crowd-sourced management of the contents of search terms databases (global, group, and local scope).

Self-adapting menus learn from user's patterns of behavior and result in fast access to the most frequently used features. Moreover, if users decide to synchronize their usage preferences, they may access and use the same interface on each device.

Self-generated action shortcuts are created after a repeated use of the same linear sequence of events, such as described in Example 3 below. In this case, tapping on the first item of the sequence: ‘Weather’ would produce same result as tapping on the last item of the sequence: ‘Hourly’. Additionally the user will have presented the path listing all skipped steps linked to the intermediate events, such as: ‘Weather’>‘My Location’>‘Hourly’. If the user changes her mind and wants to explore other than ‘Hourly’, she can select and tap ‘My Location’ and go to the skipped step of selections.

The essence of the method of assembly of search queries is in its intuitive method of placing search terms in conceptual containers assigned to handle various components of a search query. The initial choices can be presented in the same choice of configurations as are available to self-adapting menus or action selections, and can take advantage of self-generated action shortcuts. This method also enables a user to perform complex searches with minimal typing.

### BRIEF DESCRIPTION OF TABLES AND DRAWINGS

All referenced tables and figures illustrate a set of possible embodiments of this invention

TABLE 1 illustrates various examples of search categories' options:

In TABLE 1A the “advanced” examples include hierarchies starting with Numbers, Languages, Regions, etc.

The File type hierarchy tree is continued in TABLE 1B, whereas the Books-content category begins in TABLE 1B and is continued in TABLE 1C.

TABLE 2 shows a sample of search query results, as explained in Case 2 below

Each of the figures listed below contains a single view of a graphic user interface (GUI). Capital letters in the English alphabet exemplify subsequent snapshots of GUI as users proceed with their tasks.

FIG. 1: Database search query, as explained in Case 2 below

FIG. 1A: is a snapshot of the starting GUI

FIG. 1B shows the selection of “Similar spelling” as a search mode, “Northwind.accdb” as a source and of the “USA” as an excluded region

In FIG. 1C the values shown in FIG. 1B had been dragged to place holders represented by the defaults

FIG. 2: Selection of complex terms of internet search, as explained in Case 3 below

FIG. 2A is a snapshot of the starting GUI.

In FIG. 2B, a user has entered the “toxicity” as a Search Term, selected “.com” as a top level domain and selected the range of dates from Aug. 27, 2002 to Feb. 5, 2009.

In FIG. 2C, a user has dragged the choices from FIG. 2B to appropriate defaults. The date range is now in the “included” area, whereas the “.com” is in the excluded area. The additional selections are: another date range (from Aug. 27, 2002 to Feb. 5, 2009) and “fluoroquinolone antibiotics” as an additional Search Term.

FIG. 2D exemplifies the inclusion of the latter data range and the latter Search Term and a selection of “aquatic organisms” as an additional Search Term and a selection of date range with the upper limit of Oct. 21, 1995.

FIG. 2E shows that the date range up to the upper limit selected above is excluded from the search query and the “aquatic organisms” term is included in the query.

FIG. 3: Browsing through a selection of menus, as explained in Case 4 below

FIG. 3A shows default menu options.

The first set of menu selections is presented in FIG. 3B

The second, concurrent set of menu selections can be seen in FIG. 3C

FIG. 4: Browsing through a hierarchy of categories—tumble wheels, as explained in Case 5 below

FIG. 4A shows the default starting GUI.

In FIG. 4B, a user has made the first choice of “File type” category by “scrolling and image of a tumble wheel.

By a horizontal drag, the user has invoked the next level of options for “File Type” as it can be seen in FIG. 4C.

FIG. 4D shows the selection of “Documents” as the “file type”

In FIG. 4E, the user approved the selection of “Documents” and has moved the finger/stylus/pressed right arrow/pronounced a command to invoke the next tumble wheel with the set of optional file extensions.

The process of selection is completed by choosing the “.doc?” as a file extension in FIG. 4F.

FIG. 5: Search launched from the Start window, as explained in Case 6 below

FIG. 5A is the starting GUI.

In FIG. 5B a user selects the “Shop” tile in the top right corner.

In FIG. 5C; all tiles move to the left to make space for a tumble wheel representing shopping categories. The user selects “Fasion”.

Another tumble wheel appears in FIG. 5D. User selects “Shoes & boots”.

FIG. 5E: Default tiles move to the left. User selects “Boat shoes” in the next tumble wheel.

FIG. 6: Menu shortcut, as explained in Case 7 below

FIG. 6A shows the default starting GUI.

In FIG. 6B, user invokes the last operation.

FIG. 6C shows the result of the last used chain of selections, the hourly weather.

In FIG. 7, the alternative graphic elements are shown, as explained in Case 8 below

### DETAILED DESCRIPTION OF THE INVENTION

The operation of various embodiments of the invention is explained using attached Tables and Figures

In the following examples the representations of interface are not consistent. The inconsistency serves as remainder that the appearance and the configuration of an interface is self-adapting to the user's needs, usage patterns and can be intentionally configured by a user.

The search query interface is auto-configurable, or can be configured manually (vocally in case of the audio interface). In a default configuration it may contain such areas as
search term selection and entry,
filters,
sort order,
included terms (identified by a plus sign icon),
excluded terms (identified by a minus sign icon)

The details are contained in the descriptions of the following cases:

### Case 1

A subset of query elements (terms, categories, etc.) is shown in Tables 1A, 1B and 1C.

The terms are arranged in a hierarchy and may be stored on an independent network of search term servers, synchronized periodically from time to time to ensure global consistency. The maintenance of the database can be crowd-sourced and/or automated, i.e. users would submit new terms, vote either actively by registering their ‘likes’ or ‘dislikes’, or vote passively—by the frequency of usage.

Some of the terms might be multi-located, i.e. they may belong to in different parent lists (e.g. ‘.doc?’ may belong to ‘File types’ and to ‘Filename extensions’) without interfering with the integrity of the database.

### Case 2

Database Search Query

A user wants to extract ‘Company’ and ‘Country’ information from all countries except USA from “Customers' table of the ‘Northwind.accdb’ database. This can be translated to SQL Query:
SELECT Company, Country FROM Customers WHERE Country< >‘USA’

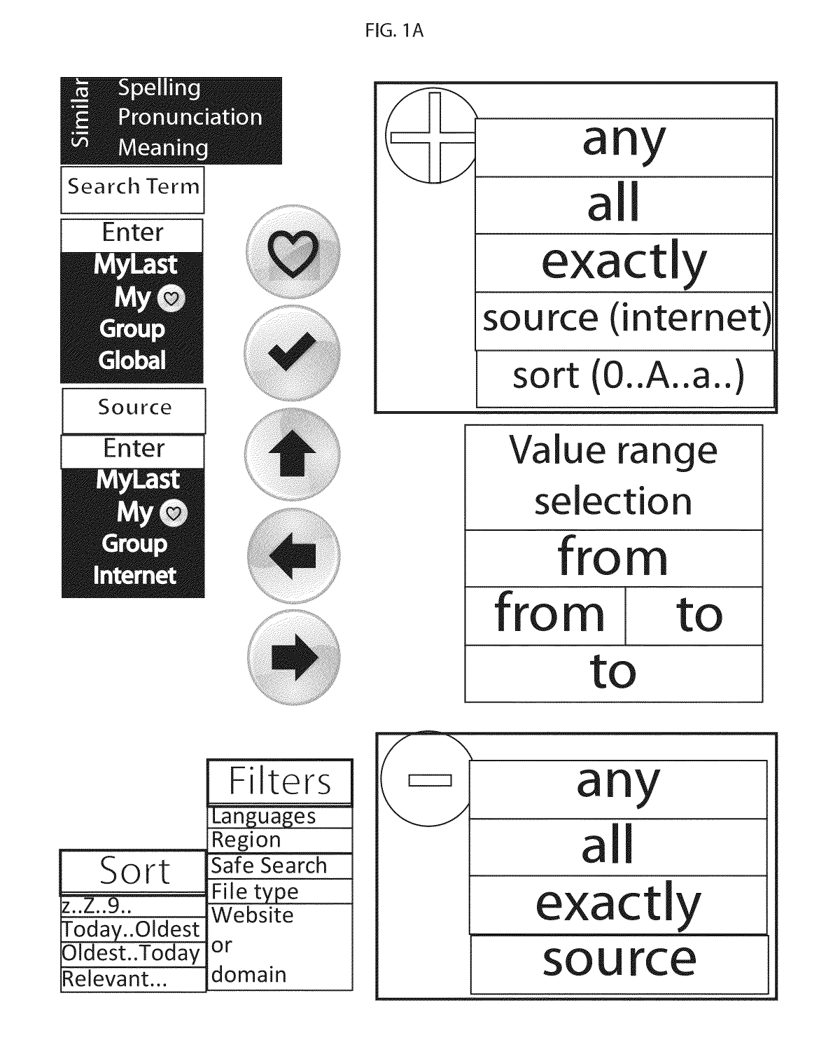

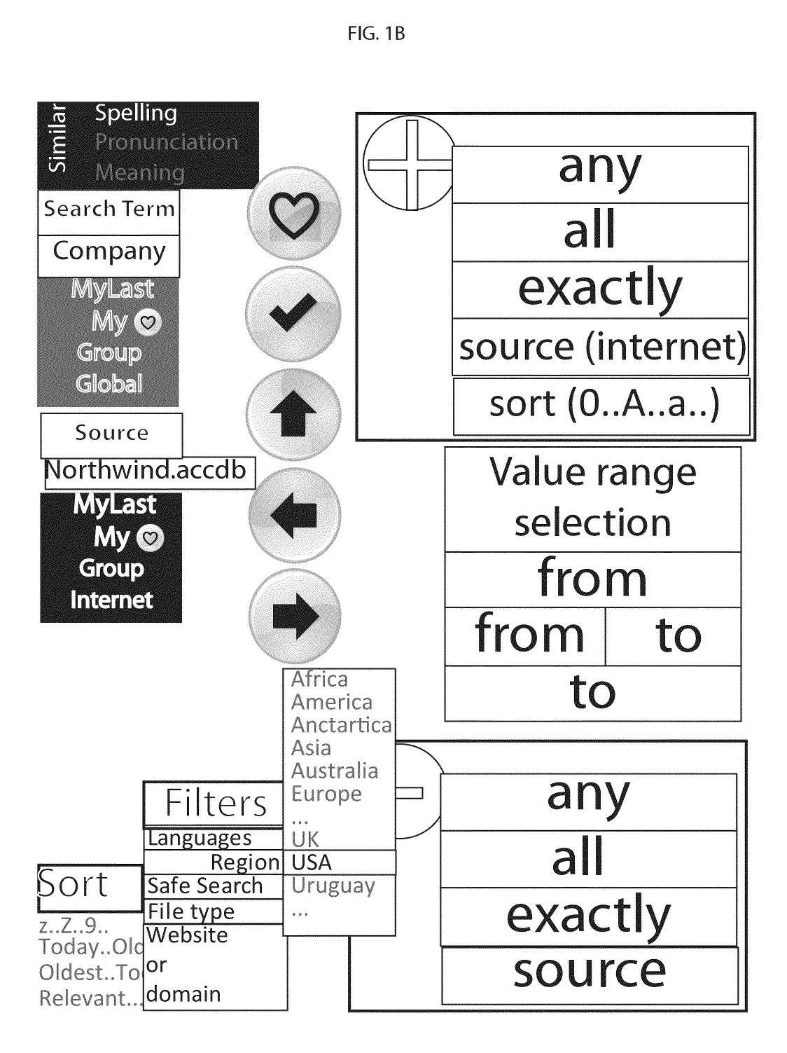

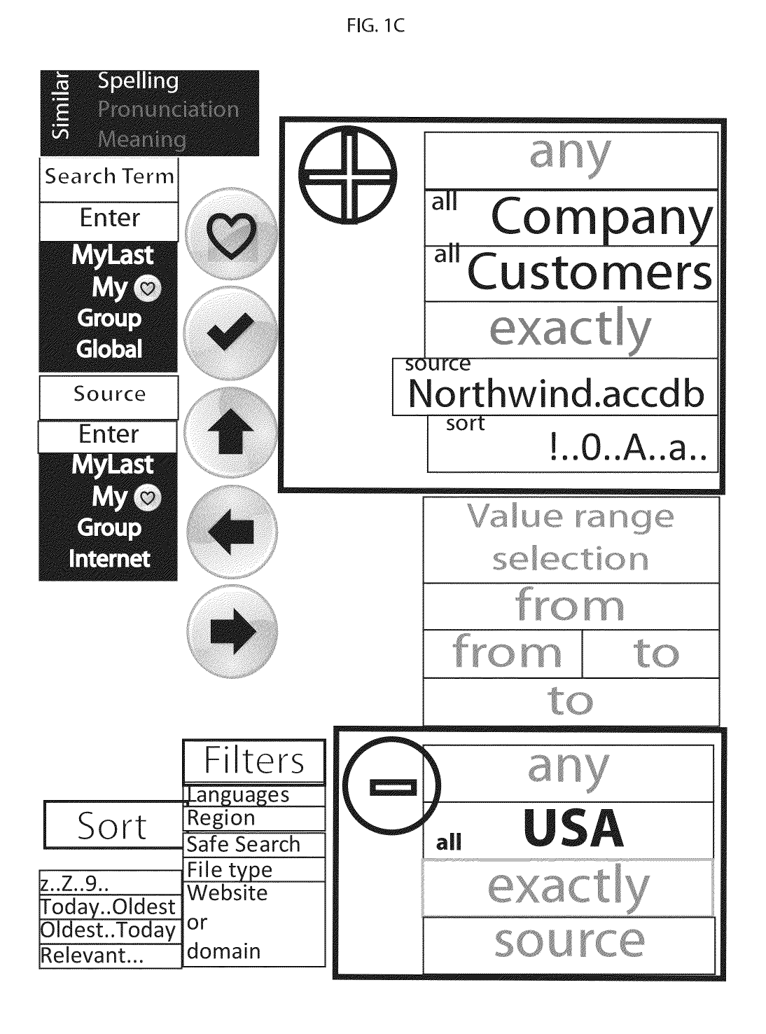

This invention enables a user to assemble a query by dragging and dropping search terms across the interface as it is shown in the FIG. 1A FIG. 1B and FIG. 1C or by pronouncing appropriate commands.

After approving the desired interface configuration, a user may want to do the following
approve it by selecting a checkmark icon,
save as her favorite configuration (represented here by a heart icon),
proceed with a selected action by selecting a right arrow icon,
step back using a left arrow icon,
return to the start without resetting the selections by selecting the “up” arrow icon,
reset the selections by selecting the up arrow icon again.

By dragging “USA” to the ‘Excluded’ area of the interface (marked by the encircled minus sign), the selected query contains exclusion of companies located in the USA (FIGS. 1B and 1C).

The results of the search are shown in Table 2

### Case 3

Complex Terms of Internet Search

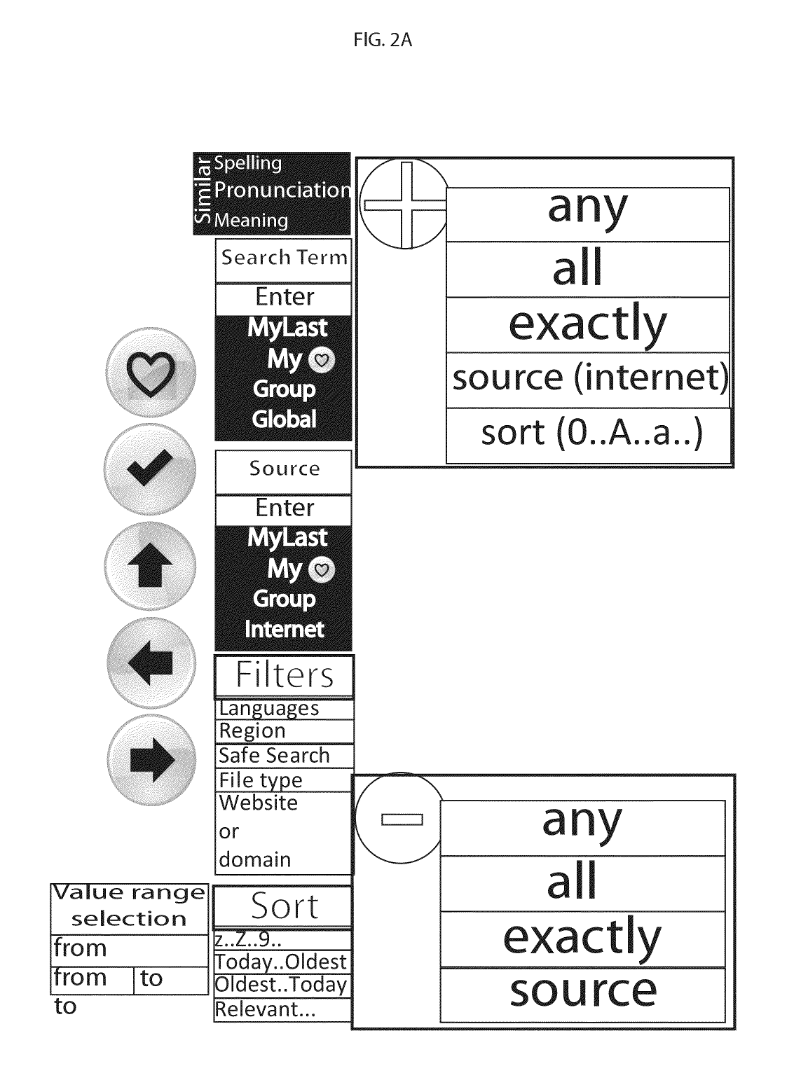

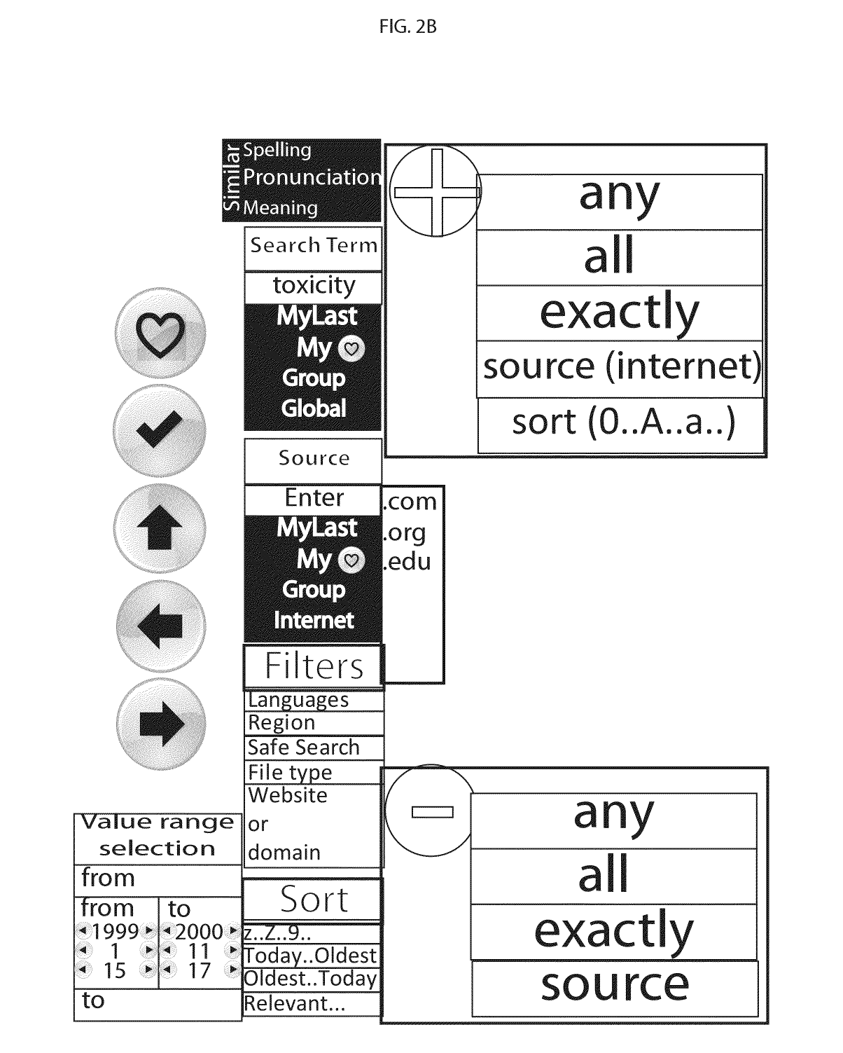

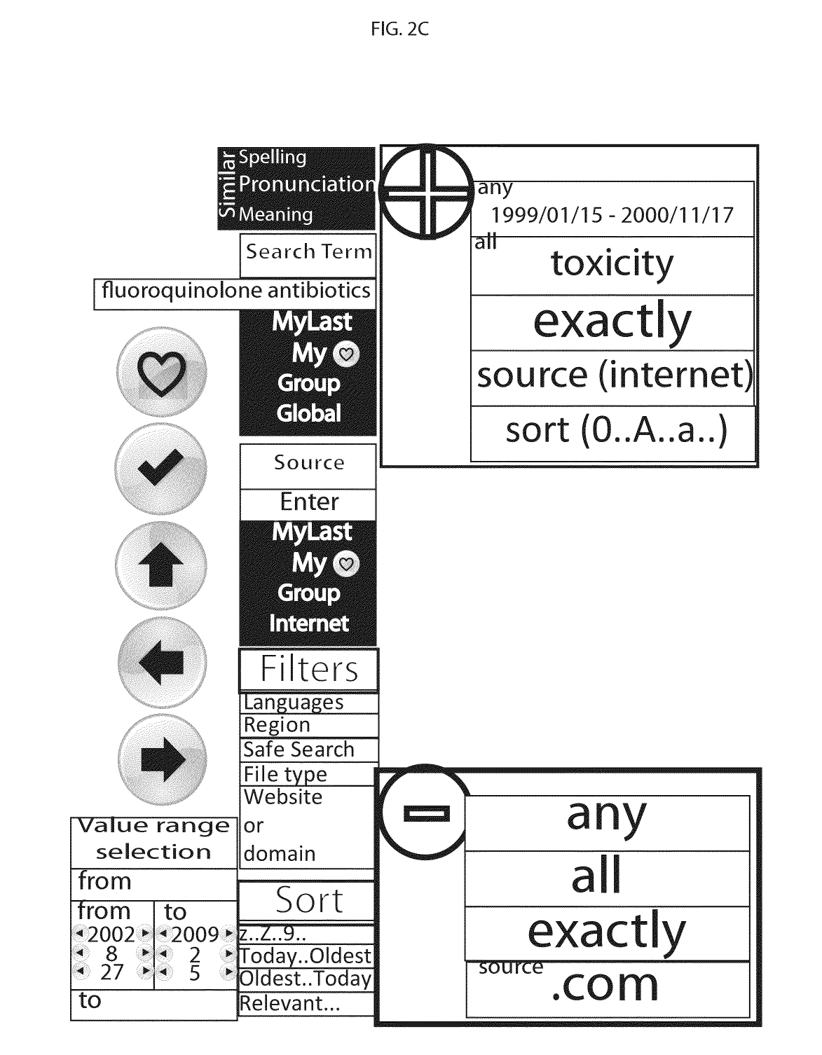

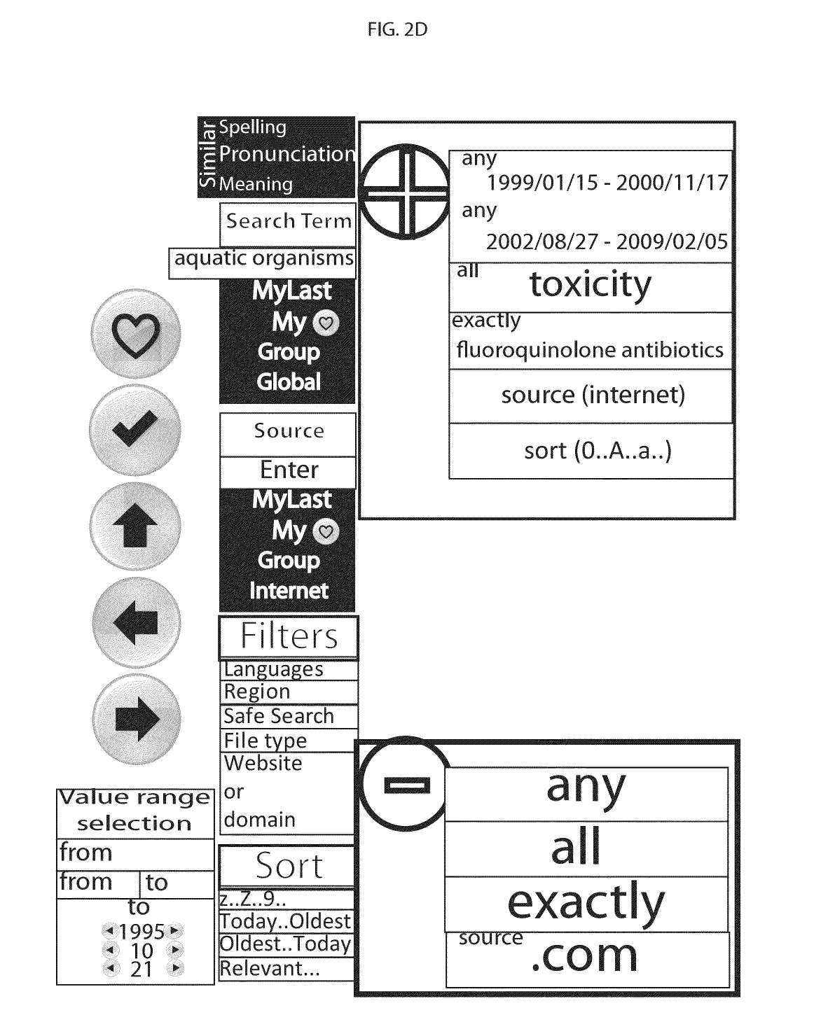

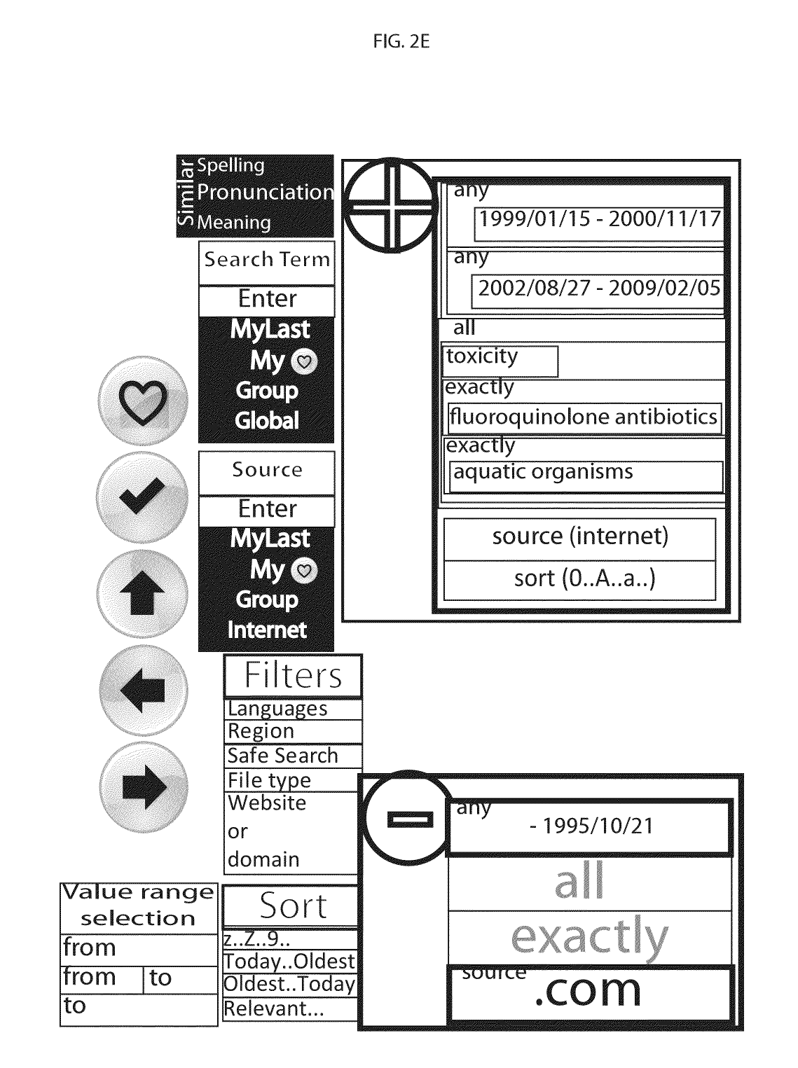

A user wants to find information on ‘toxicity’ of ‘fluoroquinolone antibiotics’ to ‘aquatic organisms’ on internet excluding ‘.com’ websites. The sequence of interfaces leading to the completion of query is shown in FIG. 2A, FIG. 2B, FIG. 2C, FIG. 2D, and the final configuration of query in FIG. 2E.

The final query contains terms: ‘toxicity’ AND ‘fluoroquinolone antibiotics’ AND ‘aquatic organisms’ dated (from Jan. 15, 1999 to Nov. 17, 2000) OR (from Aug. 27, 2002 to Feb. 5, 2009) not containing any dates prior to Oct. 21, 1995

### Case 4

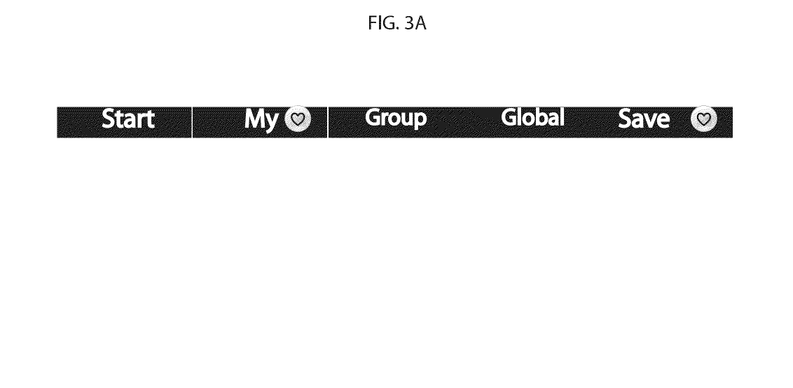

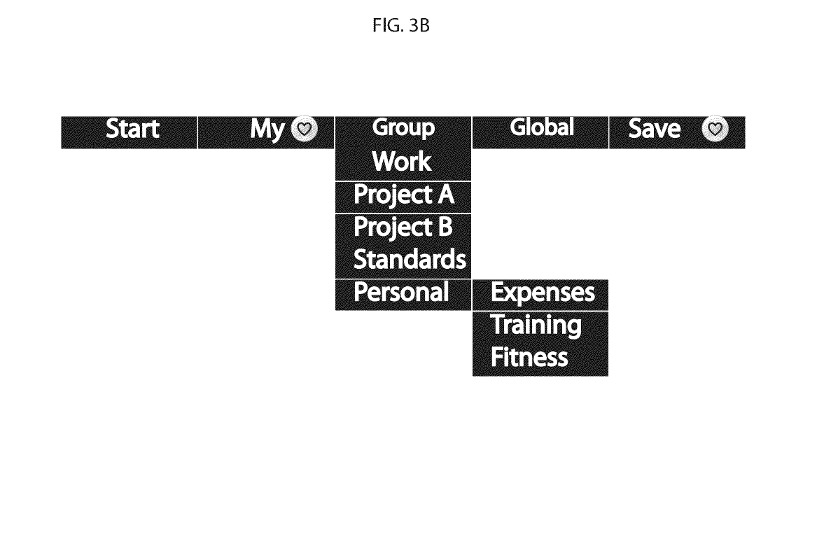

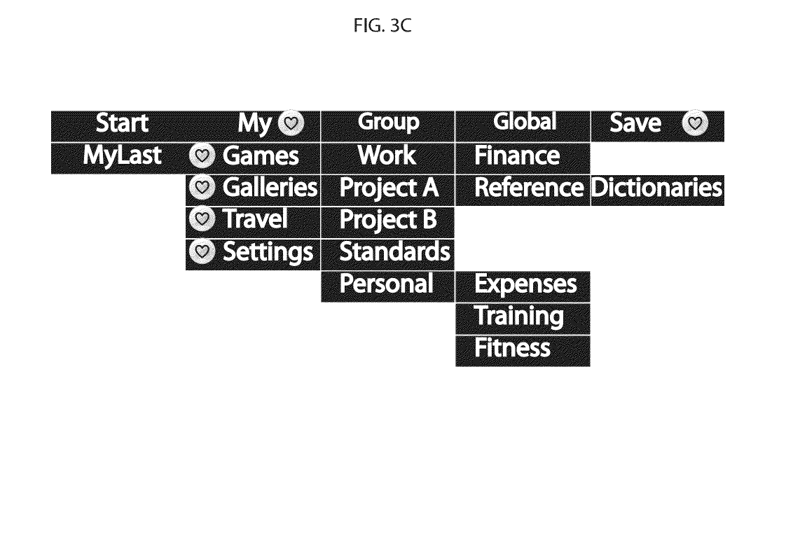

This sequence of interfaces contains various menu selections as is being used in the prior art. However, according to this invention the browsing query can be defined using multiple menu choices. The process is shown in FIG. 3A, FIG. 3B and FIG. 3C.

### Case 5

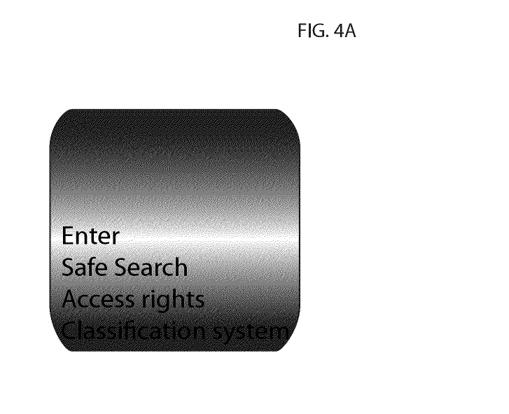

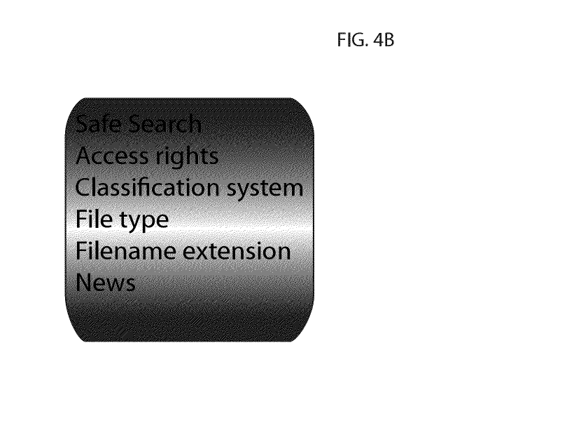

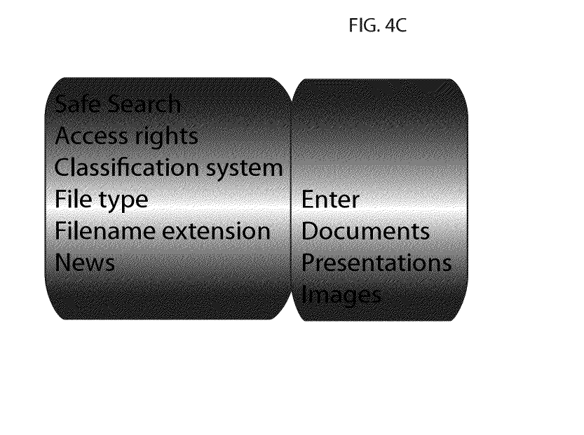

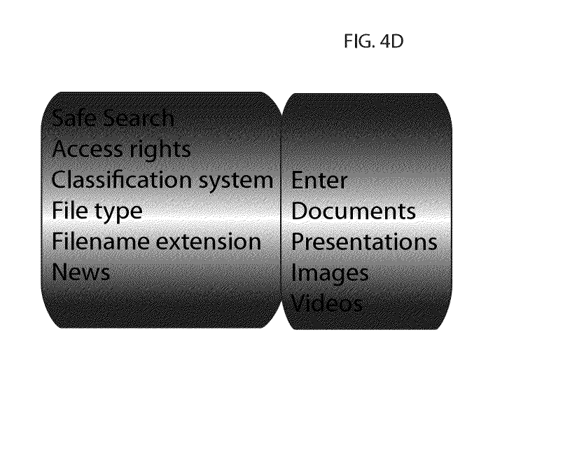

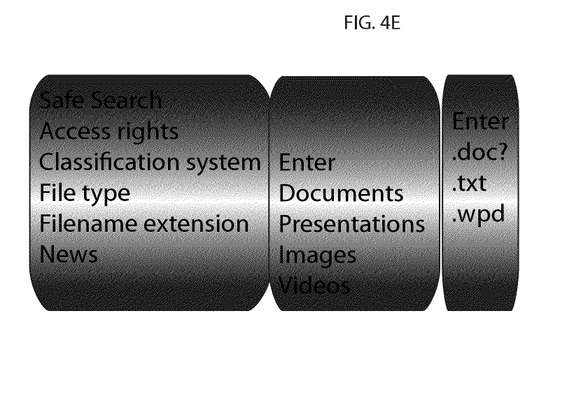

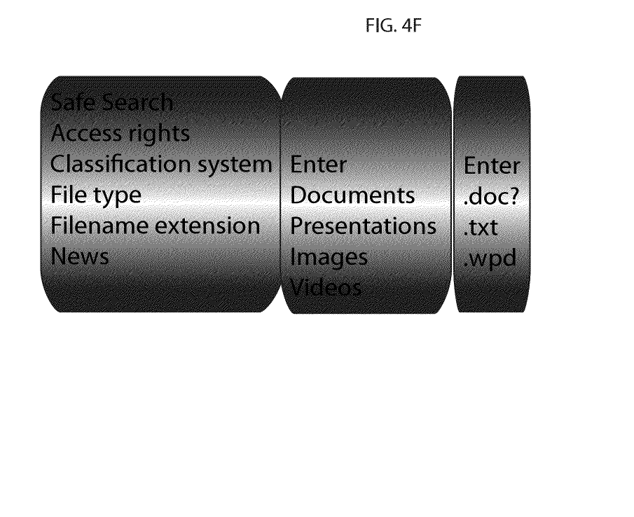

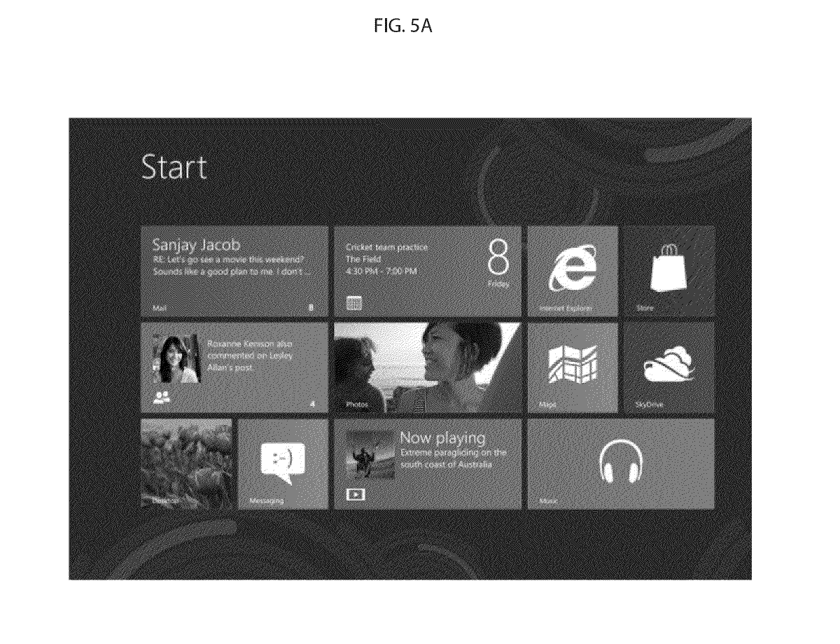

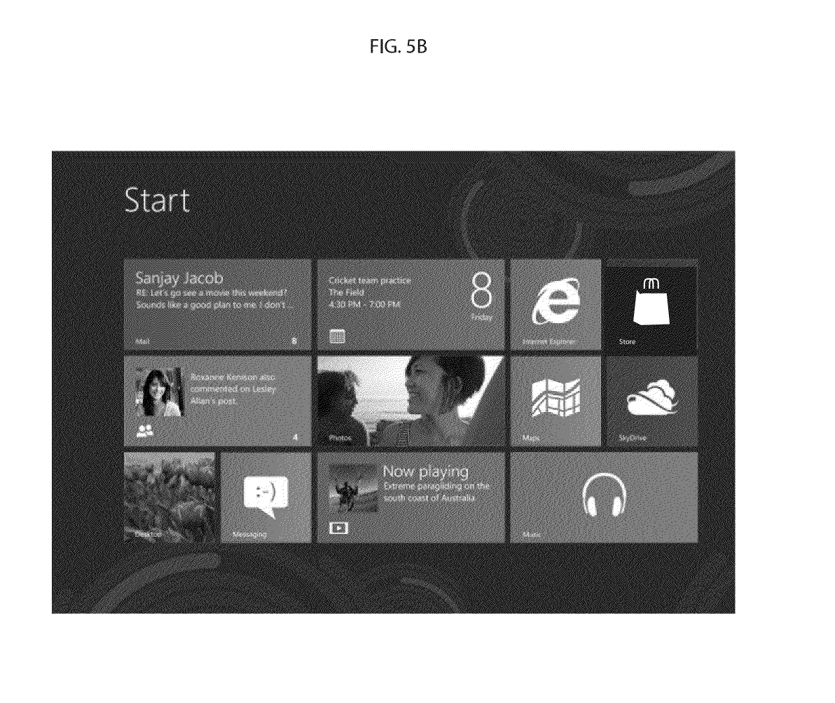

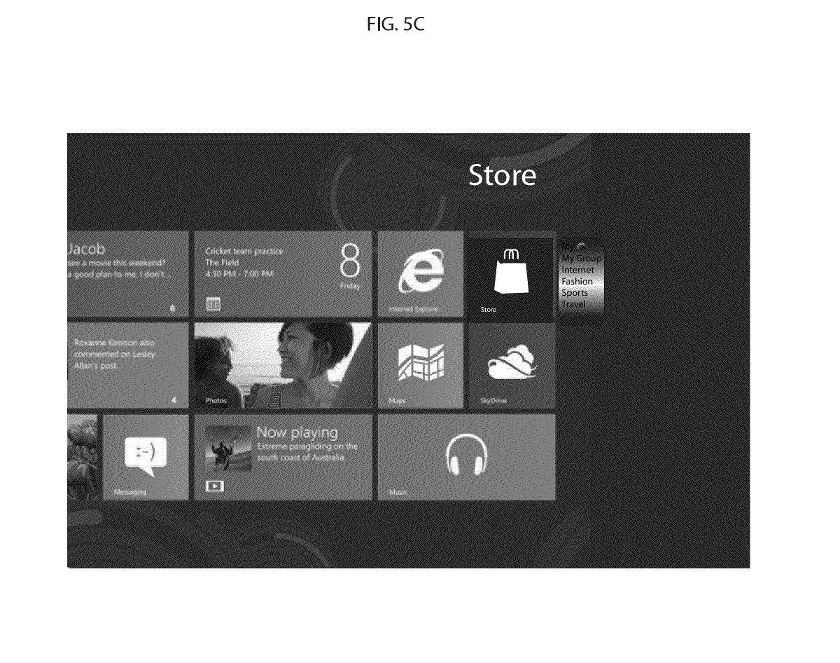

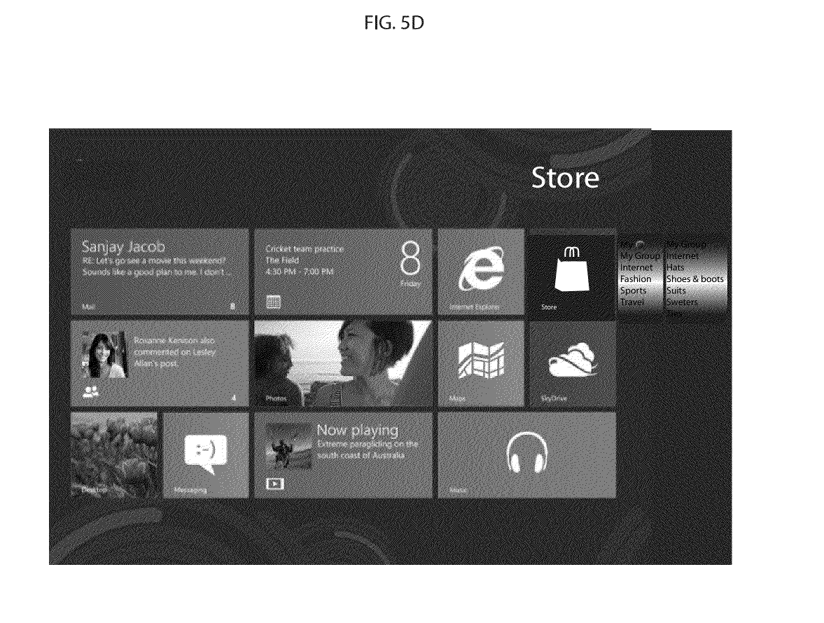

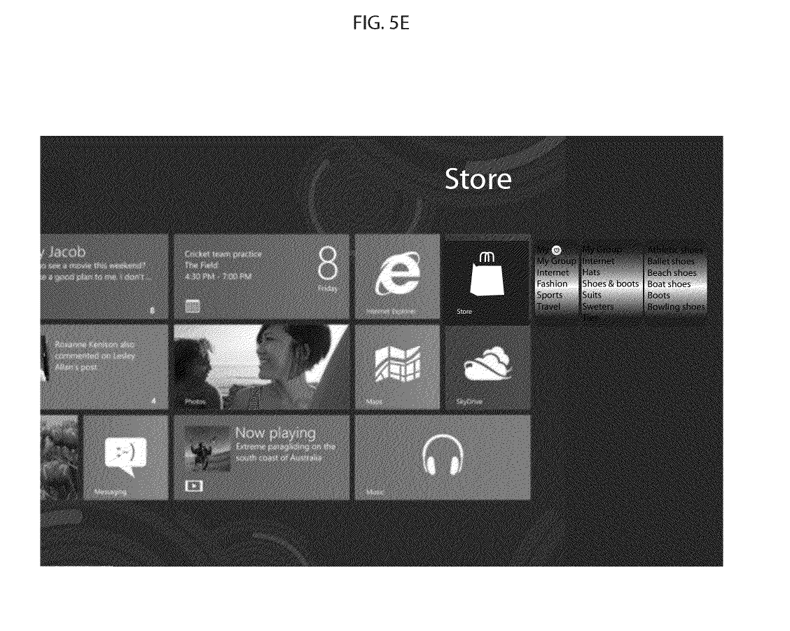

Extendable Tumble Wheels-Concept of a Cascaded Tumble Wheel Menu Selection Illustrated in FIG. 4

This implementation of the invention facilitates browsing through hierarchies and sub-hierarchies. A user initializes the browsing by a predefined event (sliding a finger, dragging a mouse, pronouncing a command, etc.). The first tumble wheel appears. Users may enter a value of an entry, or select their defaults such as last entry, their favorite entry, their group entry, select global or internet defaults, or scroll through set of defaults they selected. After placing their desired selection at the most focused location of the tumble wheel, they may invoke a next tumble wheel with a list of categories (terms) assigned to the focused term. Then they can scroll again and invoke a next tumble wheel after finding the most relevant entry. These steps may be repeated until users narrow down the terms to the required scope range. After finding a useful combination of terms, they can memorize their favorite set by selecting ‘save favorites’ (save ♡) action.

### Case 6

In this case, the search is launched from the Start window

A user browses through various selections of shoes using the concept of extendable tumble wheels such, as presented in CASE 5.

### Case 7

Menu Shortcut

A user wants to know the hourly weather forecast on her phone. So every day she turns on the phone, taps on ‘Weather’ rectangle, then taps on her present location icon, taps ‘More’, taps on “Hourly’ and starts scrolling up and down the list of hourly weather conditions. In short, the sequence of events is: select and tap ‘Weather’>select and tap ‘My Location’>select and tap’>browse.

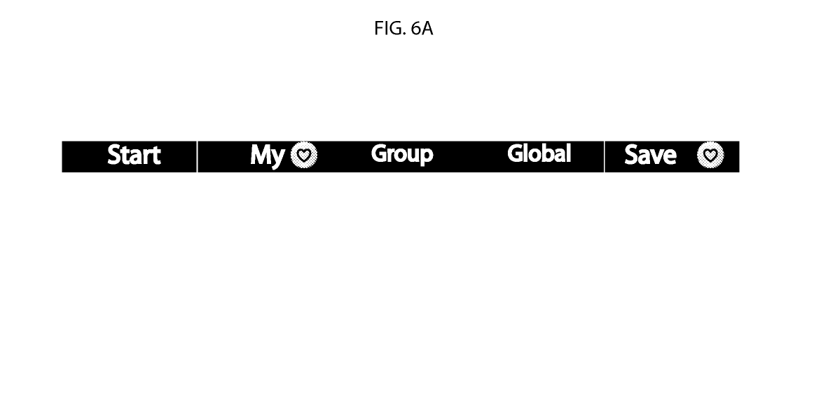

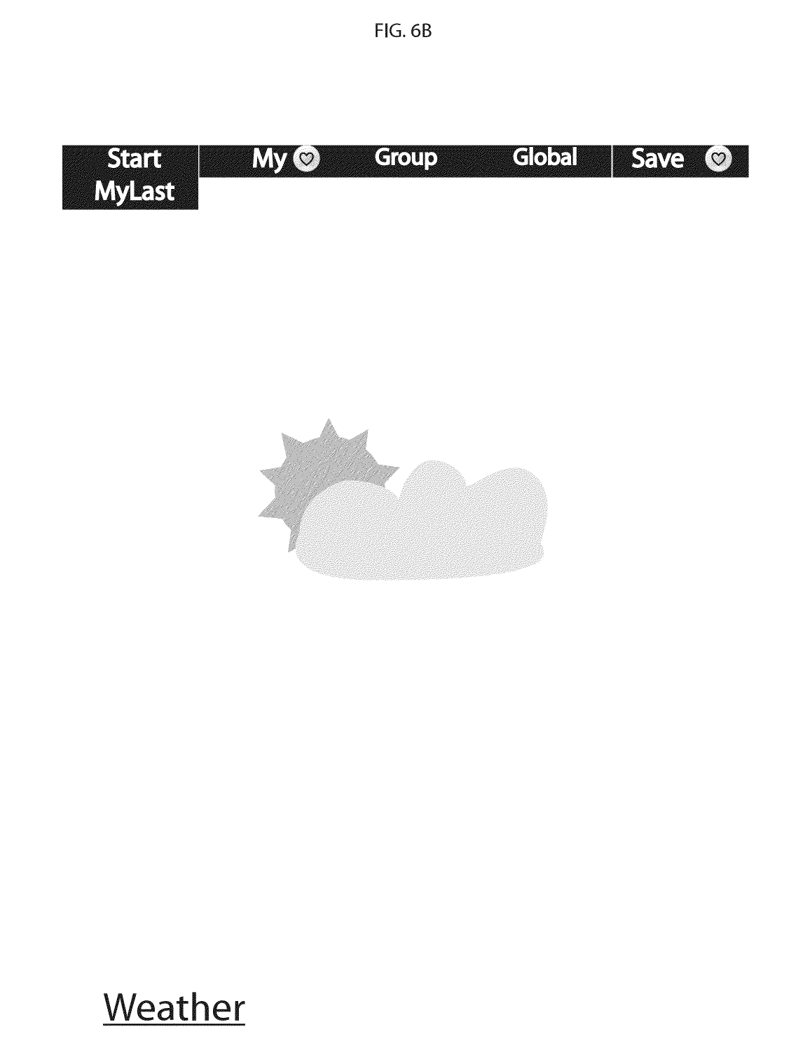

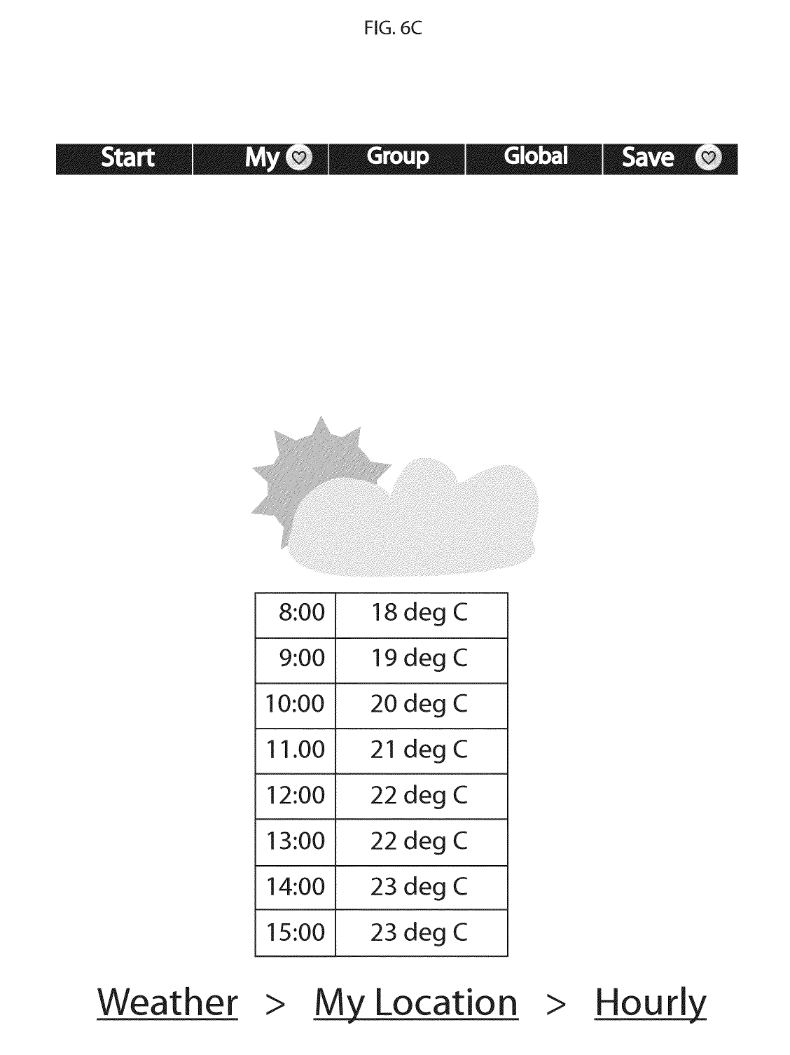

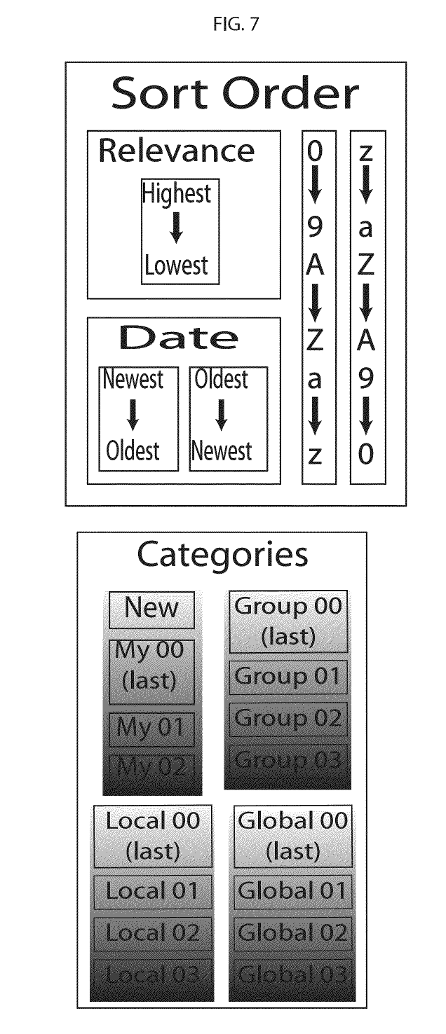

After the repetition of this series of selections several times (the threshold number of repetitions being the default value, customizable), the selection of the ‘Weather’ will result in the display of ‘Hourly’ as shown in FIG. 6C. To allow backtracking and branching out to a different outcome, a user is presented with a trace of skipped commands (breadcrumbs).

### Case 8

Alternative Graphic Elements

There is an endless choice of graphic designs that can improve user's interaction with the interface. Examples of yet another designs are shown in FIG. 7.

In the Figures referred to in this disclosure, the graphic objects may be animated by expanding, enhancing, magnifying, highlighting, etc., of selected objects whereas de-selected objects may be faded out, moved out of the interface, contracted, etc.

TABLE 1A
Sample of search categories - part 1

| | | |
|---|---|---|
| Numbers | Last update | Safe Search |
| Enter | Any time | Show all |
| Including | Last 24 hours | Moderate |
| From . . . | Last week | Strict |
| To . . . | Last month | Access rights |
| Languages | Last year | read |
| Enter | Last 2 years | write |
| Afrikaans | Last 5 years | delete |
| Arabic | Last 10 years | publish |
| Region | After . . . | modify |
| Enter | Before . . . | unknown |
| Continents | After . . . and before . . . | Classification system |
| Africa | Website or domain | Enter |
| America North | International | International Patent Classification |
| America South | .com | Colon Classification |
| Asia | .net | Dewey Decimal Classification |
| Alliances | .info | File type |
| ASEAN | .biz | Enter |
| Commonwealth | .org | Documents |
| EU | Country specific | Word Processing |
| Countries | .ca | .doc? |
| Afganistan | .fr | .wpd |
| Albania | .pl | Spreadsheets |
| Algeria | .ru | .xls? |
| Angola | .uk | .qpw |

TABLE 1B
Sample of search categories - part 2

| | | |
|---|---|---|
| Presentations | News | Sport |
| Slide Shows | Enter | Enter |
| .pps? | My last | Team Sports |
| .*odp | My favourite | Enter |
| Images | Group | Baseball |
| Videos | Enter | Football |
| Sounds | Family | Individual Sports |
| Text | Friends | Track and Field |
| Compiled | Workgrup | Sprint |
| Windows | Association | Enter |
| .exe | Area | 100 m |
| .dll | Local | 200 m |
| Filename extension | City | Javelin |
| Enter | Region | Long distance |
| A | State | 1k |
| .a | Politics | 3k |
| .a00 | Culture | 10k |
| .add | Enter | Books -content |
| .acc | Multimedia | Enter |
| .accdb | Graphics | Fiction |
| B | Video | Enter |
| .b | Sounds | Poetry |
| .b1 | Literature | Prose |
| .bak | Fiction | Novels |
| .bat | Science-Fiction | Scripts |

TABLE 1C
Sample of search categories - part 3

| | | |
|---|---|---|
| Non-fiction | Encyclopedias/Wikis | Computer software |
| Enter | Enter | Enter |
| Sciences | Encyclopedias | Drivers |
| Arts | Wikis | Operating systems |
| Engineering | Dictionaries | Applications |
| Law | Enter | Games |
| Home | Definitions | Firmware |
| Books - format | Acronyms | Ratings and reviews |
| Enter | Bilingual | Enter |
| Paper | Synonyms (Thesaurus) | Ratings |
| eBooks | Blogs | Reviews |
| Other | Enter | Scope of extraction |
| Periodicals | General Info | Enter |
| Enter | Politics | Names |
| Annual | Local | Enter |
| Quarterly | Foreign | Highlighted |
| Monthly | Culture | Places |
| Weekly | Movies | Enter |
| Daily | Sport | Highlighted |
| Irregular | Questions | Organizations |
| Conferences | Enter | Enter |
| Announcements | Open | Highlighted |
| Agendas | Closed | Dates |
| Proceedings | Resolved | Enter |
| Webinars/Webcasts | Unresolved | Highlighted |

TABLE 2
Case 2 search query result

| Company | Country |
|---|---|
| Island Trading | UK |
| Galería del gastrónomo | Spain |
| Laughing Bacchus Wine | Canada |
| Cellars | |
| Paris spécialités | France |
| Simons bistro | Denmark |
| Wolski Zajazd | Poland |

1. A self-configurable and user-configurable Graphic User Interface, Audio User Interface (such as stream of voice announcements) or Tactile User Interface populated initially with system defaults derived from a local or a remote database or sandboxed databases, wherein the components of the said interface are configured using input devices such as, but not limited to:
a keyboard, a mouse, a trackball, a joystick, a pen, a stylus, a touch screen, a touch pad, a gravitational sensor, an accelerometer, a microphone, a camera or a neurosensor; with a capability to select the last configuration or the most frequently used configuration in a selectable time period (such as from a defined start date/time to a defined stop date/time) and with a capability to select said configuration invoked by an user, a group of users by association level (such as subscribers, members, affiliates, coworkers, etc.), wherein the said capability is available to any user or to an authenticated and/or authorized user.

2. The interface as claimed in 1, wherein the components such as but not limited to: constants, parameters, variables, objects, procedure calls of the said interface are stored in the said database as uniquely identified records and after each view, selection or use are appended with a single or a multitude of any of the following attributes:
a related operating system or an application used—identified by the parent's identification (code, token) thereafter designated as ‘ID’,
an action called by a selection (an application, an object, a process, a service, etc.)—identified by application, object, process, service, name or ID
the recently selected interface—identified by the ID of the recent interface,
the previously selected object—identified by the ID of the previous selection,
previously activated selection (previous event)—identified by the event's ID,
a related screen—identified by the active screen's ID,
an on-screen position—specified by horizontal and vertical absolute or relative to the neighbor on-screen position
use indicator, such as but not limited to: viewed, displayed, announced, selected, read, time displayed, modified, saved, moved, copied, downloaded, uploaded, transmitted,
an absolute or a relative layer depth coordinate,
graphical component size parameters: static sizes, or dynamic size ranges
an opacity
a sound level,
if a user chooses selectable time period capability as claimed in 1, a timestamp;
and—if a user opts for synchronization of the components of the said interface, the user's ID, the definition of the component's meaning and cross-references to supporting information.

3. The interface as claimed in 2, wherein the sequences of selections of said components are recorded in a database, wherein criteria to determine redundant sequences of events are established and managed through a suitable interface, and—after several repeats of a sequence the start of the frequently repeated sequence leads to the end of said sequence whereas the said sequence is presented to the user as described in claim 1 with an option to undo any number of steps of the said sequence.

4. The interface as claimed in 2, wherein a user can navigate through selections, with the aid of components such as but not limited to:
navigation components, and—optionally context-dependent—selection tools, such as but not limited to: ‘approve’, ‘cancel’, ‘return to previous configuration’, ‘go to the next configuration, ‘go to the initial configuration’, ‘find’, ‘select all’, ‘deselect’, ‘deselect all’, ‘record preferred selection’, ‘list preferred selections’, ‘change priorities of preferred selection(s)’, ‘delete preferred selection(s);
suitable filters such as but not limited to: ‘my last selection’, ‘my preferred selection’, ‘my group's selection’, ‘internet’;
and a selection of a sort order and wherein all said components are optionally scrollable and emphasized at the location of the focus area.

5. A system to interact with the interface as claimed in 2, comprising a server (local or remote), a multitude of interconnected servers or any combination thereof with suitable software to allow and enable incremental, differential or batch synchronization between a user (client) and a server and between said servers according to selected authorization and association levels.

6. The system as claimed in 5, wherein the synchronization between clients and servers or between servers is run periodically in batches.

7. The interface as claimed in 1, wherein the components of the said interface belong to a menu of choices for an operating system or a software application.

8. The interface as claimed in 2, wherein the components of the said interface constitute the elements of a search query.

9. The interface as claimed in 7, wherein search terms can be entered by a user, or selected from categories such as, but not limited to: database location, database scope, format of the elements collection (movies, books, multimedia files), professional directories, occupation codes, patent classes, said categories extended by subcategories, wherein the said categories and subcategories have settable modification and moderation privileges assigned to authenticated and authorized individuals and/or groups.

10. The interface as claimed in 7, wherein the selection of search terms is complemented by a selection of suitable filters, sort order and other search attributes.

11. The interface as claimed in 10, wherein the initial menu contains and enables the choice of the attributes applied to search terms, such as, but not limited to:
source (of information): my last source, my favourite source, my workgroup source, my association source, my neighborhood source, my city source, my region source, my country source, internet (as a source);
similar spelling, similar meaning (synonyms), opposite meaning (antonyms), similar pronunciation (homonyms);
the selection of filters such as but not limited to: language(s), database(s), website(s) or domain(s);
file type(s);
intellectual property rights;
the selection of sort order such as, but not limited to:
0 . . . A . . . a . . . (ASCII)
z . . . Z . . . 9 . . . (inverted ASCII), newest . . . oldest, oldest . . . newest, relevant . . . less relevant (sorted by a number of positive matches);
and the assembly of a search query is accomplished by dropping and dragging search terms into two distinctive screen areas:
the first said area for included terms,
the second said area for excluded terms;
whereas each area comprises subareas such as, but not limited to:
the first subarea—for a combination of terms included in the ‘OR’ part of a query,
the second subarea—for a combination of terms included in the ‘AND’ part of a query,
the third subarea—for a combination of terms included in the ‘FROM’ part of a query,
the third subarea—for a combination of terms included in the ‘TO’ part of a query,
the fourth subarea—for a combination of terms included in the ‘FROM . . . AND . . . TO’ part of a query,
the fifth subarea—for a combination of terms included in the ‘WHERE’ part of a query.

12. The interface as claimed in 11, wherein said areas and subareas can be individually enabled, hidden, disabled, dynamically sized and positioned, copied and nested within each other while complying with the constraints of a query code, script, or language such as, but not limited to, SQL, UnQL, DDL, XQuery.

13. The interface as claimed in 11, wherein search terms and filter selections are presented in extendable and scrollable lists or menus.

14. The interface as claimed in 13, wherein out-of-focus or inactive components, lists or menus are not presented (faded out, dissolved, moved out or not announced) to the user of the interface as claimed in 1 in order to make space or to provide readability for the in-focus or active components of the said interface.

15. The interface as claimed in 8, wherein after entering a search term, a user should be presented with similar existing entries to choose from; if after the review, a user wants to submit a new global term, the new entry shall be published on ‘pending terms’ website or page and if approved by public voting either actively by registering their ‘likes’ or ‘dislikes’, or passively—by frequency of usage, the new term shall be entered into the depository of terms (global, regional, group, local, private, etc.) with the exception of specialized classifications integrated into the said databases of categories which might have specific rules of approval and inclusion of the said terms.

16. The interface as claimed in 2, wherein a user can submit a new feature, or a comment on existing properties, characteristics, functionalities, features and benefits of software, hardware or a system, and the client software will append that information to related records in the said database.

17. Activation of a selection of an element of “selection trace” (history) returns to that selection. A different selection mode, such as, but not limited to, a double click erases the trace from that point.
